(19) United States
(12) Patent Application Publication
(10) Pub. No.: US 2015/0078413 A1
(43) Pub. Date: Mar. 19, 2015

(54) Method for monitoring a fuel temperature sensor

(71) Applicant: Andreas Heinrich, Waiblingen (DE)

(72) Inventor: Andreas Heinrich, Waiblingen (DE)

(73) Assignee: Robert Bosch GmbH, Stuttgart (DE)

(21) Appl. No.: 14/487,270

(22) Filed: Sep. 16, 2014

(30) Foreign Application Priority Data
Sep. 17, 2013 (DE) 10 2013 218 608.8

(51) Int. Cl. G01M 15/04; F02M 65/00; G01K 15/00; F02D 41/22

(52) U.S. Cl. CPC G01M 15/048; F02D 41/222; F02M 65/00; G01K 15/005
USPC 374/1

(57) ABSTRACT

A method for monitoring a fuel temperature sensor over a repeating cycle includes: estimating a first value of a fuel temperature at the beginning of the cycle with the aid of a value of at least one further temperature from the same cycle and at least one of a second value of the fuel temperature and a further temperature from at least one previous cycle; and checking whether the deviation of a temperature of the fuel temperature sensor lies within a first range around the first value of the fuel temperature.

### BACKGROUND OF THE INVENTION

1. Field of the Invention

The present invention relates to a method for monitoring a fuel temperature sensor over a repeating cycle.

2. Description of the Related Art

In modern vehicles, the temperature of fuel in an injection system of an internal combustion engine can be determined, for example, with a fuel temperature sensor when necessary.

Published German patent application document DE 10 2012 200 457 A1 proposes a method and an arrangement with which a fuel temperature in an injection system can be determined without a fuel temperature sensor. Here the temperature of a coil in a metering unit of the injection system is determined by determining its electrical resistance. The temperature of the coil depends, by way of a thermal flux from the fuel via the metering unit to the coil, on the temperature of the fuel. The temperature of the fuel can thereby be calculated.

With this method, however, it is first necessary to determine parameters that are necessary for calculating the fuel temperature. This requires that the fuel, the metering unit, and an engine be thermally equalized.

For modern monitoring systems relating to pollutant emission in a vehicle, for example onboard diagnosis (OBD), it is useful if the values supplied by a measuring instrument, for example a fuel temperature sensor, are in addition continuously plausibilized.

A plausibilization of a fuel temperature sensor upon starting of the engine cannot be guaranteed with the method recited above, since firstly parameters of the method must be determined with the vehicle in a thermally equalized state.

It is therefore desirable to furnish a capability allowing a fuel temperature sensor to be monitored, in particular in OBD-compliant fashion, upon starting of the engine.

### BRIEF SUMMARY OF THE INVENTION

The present invention proposes a method for monitoring a fuel temperature sensor at a start of a cycle, for example of a driving cycle of a vehicle. A temperature supplied by the fuel temperature sensor is checked by comparing said temperature with a fuel temperature that is calculated from further temperatures of the same and of a preceding cycle. These further temperatures can be, for example, a temperature of an engine and a reference temperature, for example an ambient temperature, that are measured in any case. If the temperature of the fuel sensor is within a first range around the calculated fuel temperature, the fuel sensor is considered plausibilized.

It is furthermore advantageous if the fuel temperature sensor is also additionally checked, in particular regularly or continuously, as the cycle proceeds, by checking whether the temperature of the fuel temperature sensor is within a second range around the calculated fuel temperature. The first and the second range can be the same or different. In the latter case different ranges can also be used for different determination methods, said ranges being adapted to the accuracy of the respective methods. The accuracy of the check of the fuel temperature sensor within a cycle can thereby be enhanced.

Advantageously, as the cycle proceeds the temperature that the fuel temperature sensor supplies is checked by ascertaining the fuel temperature with the aid of a method in which a fuel temperature sensor is not required. One such method is, for example, a method in which a resistance of an electrical component, which depends on the fuel temperature, is determined as described e.g. in DE 10 2012 200 457 A1.

In this case it is advantageous if the second range changes, in particular is made smaller, over time during a cycle. This makes it possible to take into account the increasing accuracy over time (due to thermal equilibration) of a method in which a fuel temperature sensor is not required.

The fuel temperature sensor is preferably additionally checked by comparing, at the beginning of a cycle, the temperature of the fuel temperature sensor with at least one further temperature. This further temperature can be, for example, a temperature of an engine and/or a reference temperature, for example an ambient temperature, that is measured in any case. When the vehicle is thermally equalized, for example after an extended shutoff time, the temperatures are then approximately identical. This is an additional possibility for checking the fuel temperature sensor for plausibility, and for precluding faults.

The method according to the present invention is advantageously used when, in the context of the method for ascertaining a fuel temperature without a fuel temperature sensor, a fuel temperature is ascertained by using temperatures and other parameters of an injection system of an internal combustion engine, in particular in a vehicle. An injection of fuel can thereby be controlled more accurately.

Advantageously, in the method for ascertaining a fuel temperature without a fuel temperature sensor, a parameter required for that method is determined in the course of one or more cycles with the aid of temperatures of the fuel sensor that have already been checked. One such parameter can be, for example, an initially not accurately known resistance of a coil in a metering unit of an injection system. If the determined parameter is included in subsequent cycles in the calculation of the fuel temperature, the accuracy of the method is then increased. This parameter can additionally be checked for plausibility. This yields an additional capability for precluding faults, since a deviation beyond a technically possible context would indicate a fault. It is advantageous in this case if the second range is made smaller from one cycle to a later one in order to take into account the elevated accuracy.

The method according to the present invention is preferably used to monitor a temperature sensor for onboard diagnosis, since the method ensures continuous monitoring and is thereby OBD-compliant.

A calculation unit according to the present invention, e.g. a control unit of a motor vehicle, is set up to carry out, in particular by programmed execution, a method according to the present invention.

Implementation of the method in the form of software is also advantageous since this results in particularly low costs, especially when an executing control unit is also used for further tasks and is therefore present in any case. Suitable data media for furnishing the computer program are, in particular, diskettes, hard drives, flash memories, EEPROMs, CD-ROMs, DVDs, and many more. Downloading of a program via computer networks (Internet, intranet, etc.) is also possible.

Further advantages and embodiments of the invention are evident from the description and from the appended drawings.

It is understood that the features recited above and those yet to be explained below are usable not only in the respective combination indicated, but also in other combinations or in isolation, without departing from the scope of the present invention.

The invention is schematically depicted in the drawings on the basis of an exemplifying embodiment and will be described below in detail with reference to the drawings.

### BRIEF DESCRIPTION OF THE DRAWINGS

FIG. 1 schematically shows the time sequence of one cycle of a method according to the present invention, in a preferred embodiment.

FIG. 2 schematically shows the disposition of a fuel temperature sensor in an injection system such as the one used for a method according to the present invention, in a preferred embodiment.

### DETAILED DESCRIPTION OF THE INVENTION

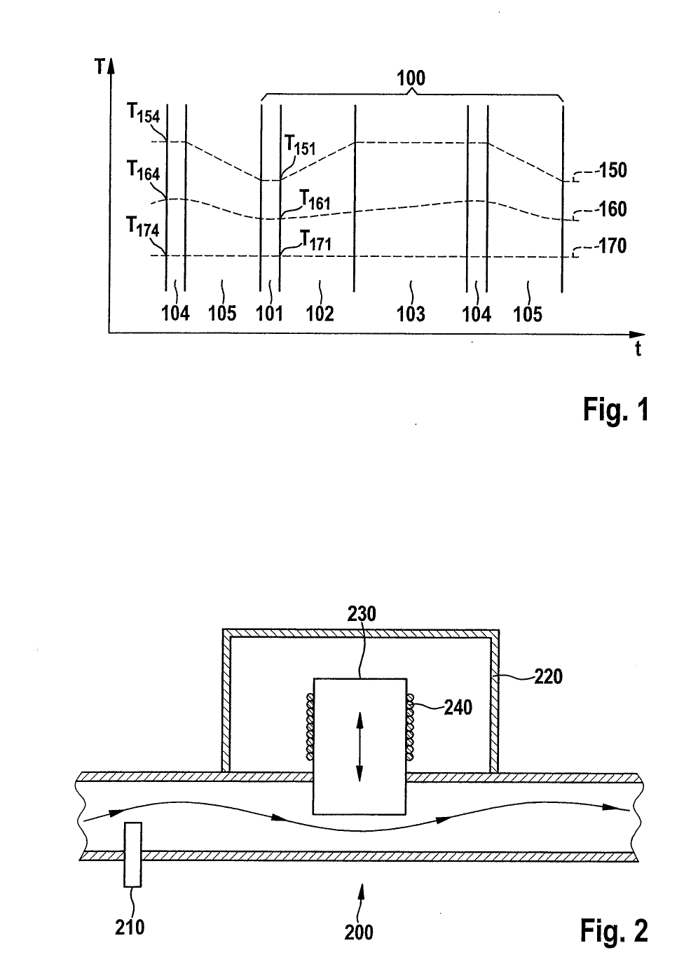

FIG. 1 schematically depicts, in a preferred embodiment, the time sequence of a cycle, manifested here as driving cycle 100 of a vehicle, of a method according to the present invention for monitoring a fuel temperature sensor. Time is indicated here from left to right, and temperatures are plotted as dashed lines.

FIG. 2 schematically shows a part of an injection system 200 that is embodied here as a fuel injection system of an internal combustion engine. The Figure illustrates a metering unit 220 containing a slider 230 surrounded by a coil 240. A fuel temperature sensor 210 is located in the flow of a fuel that is indicated here as a line having arrows.

Driving cycle 100 in FIG. 1 is subdivided into five segments 101, 102, 103, 104, and 105 that represent different phases of the driving cycle. Segment 101 represents the phase immediately after the ignition of the vehicle is switched on, i.e. starting. Here a first value T₁₆₁ of the fuel temperature 160 is estimated. The first values T₁₅₁ and T₁₇₁ of the second temperatures manifested here as engine temperature 150 and ambient temperature 170, second values T₁₅₄ and T₁₇₄ thereof, and a second value T₁₆₄ of the fuel temperature 160, are used for this. The second values T₁₅₄, T₁₆₄, and T₁₇₄ are the values of the temperatures at the beginning of fourth segment 104 of the preceding driving cycle, which represents rundown of the engine.

In order to estimate the initial first value T₁₆₁ of the fuel temperature 160, it is assumed that the engine temperature 150 and fuel temperature 160 cool down with respect to the ambient temperature 170 at the same ratio during fifth segment 105 of driving cycle 100. Segment 105 here represents a phase in which the engine is off and is cooling.

The value T₁₆₁ of the fuel temperature 160 is then calculated using the following formula (rule of three):

T₁₆₁=[T₁₅₁*(T₁₆₄−T₁₇₄)−T₁₇₁*(T₁₆₄−T₁₅₄)]/[T₁₅₄−T₁₇₄].

To estimate the fuel temperature 160 as driving cycle 100 progresses (segments 102 and 103), a method for ascertaining a temperature without a fuel temperature sensor is used.

Segment 102 represents the phase shortly after starting until, for example, approximately 500 seconds after starting, in which heat transfers in the vehicle, in particular in the injection system, have not yet equilibrated. In segment 103 thereafter, the heat transfers have equilibrated, and segment 103 lasts until the engine of the vehicle is shut off.

In the preferred embodiment, the fuel temperature 160 is calculated for this purpose by determining the temperature of coil 240 in metering unit 220 of injection system 200 of the vehicle. From this a back-calculation of the fuel temperature 160 can be made if the dependence thereof on the heat flux existing from the fuel via slider 230 to coil 240, and other requisite parameters, are known. The temperature of coil 240 is in turn gathered from its electrical resistance.

A more accurate determination of the resistance of coil 240, with reference to a correlation with production tolerances, is not necessary thanks to the calculation of the initial value T₁₆₁ of the fuel temperature 160 using the formula above.

The engine is running during segments 101, 102, and 103, and monitoring of the fuel temperature sensor is useful in particular for OBD. In these segments the temperature supplied by the fuel temperature sensor is compared with the estimated fuel temperature 160. A check is made here as to whether the difference between these two temperatures is within a range.

Because the estimate in segments 101 and 102 is more inaccurate than in segment 103, in the preferred embodiment a first range, e.g. −30° C. to +30° C., is used for segments 101 and 102 and a second range, e.g. −20° C. to +20° C., is used for segment 103. This second range can also be reduced after an extended driving period, since the system has then reached thermal equilibrium.

In segment 104, which represents rundown of the engine, the actual temperature values at the beginning of said segment 104, in particular the values T₁₆₁ of the fuel temperature 160, T₁₅₄ of the engine temperature 150, and T₁₇₄ of the ambient temperature 170, are saved, for example in the EEPROM of a control unit in the vehicle. These temperatures can therefore be used again in the subsequent driving cycle.

The method for ascertaining a temperature without a fuel temperature sensor becomes refined as the driving cycles progress. The second range can consequently be reduced. In the preferred embodiment, an initially unknown, production-related tolerance resistance of coil 240 in metering unit 220 of injection system 100 is determined for this purpose. This tolerance resistance is determined for this purpose at the end of segment 103, provided the latter has already lasted at least, for example, 1000 seconds, by back-calculation from the fuel temperature via the temperature of coil 240 to the resistance of coil 240, analogously to the method mentioned earlier. A value of fuel temperature sensor 210 already plausibilized using the above method is used as the temperature of the fuel.

This tolerance resistance of coil 240 determined in this manner, or an average of multiple determined tolerance resistance values, is saved, for example, in the vehicle's EEPROM and is utilized for calculations in subsequent driving cycles in segments 102 and 103.

The tolerance resistance determined in this manner can then also be utilized to plausibilize the tolerance resistance with respect to known tolerance resistance values that are possible in terms of production. A deviation that would not be technically possible indicates a fault.

A further plausibilization possibility is to compare the fuel temperature 160 to the engine temperature 150 and ambient temperature 170 at the beginning of segment 102, for example six seconds after engine start, when the necessary controllers have equilibrated. If the engine temperature 150 and ambient temperature 170 have approximately the same value in this phase of a driving cycle, for example after the vehicle has been unused for an extended time, the fuel temperature 160 must also have approximately the same value.

What is claimed is:

1. A method for monitoring a fuel temperature sensor over a repeating cycle, comprising:
estimating a first value of a fuel temperature at the beginning of the cycle with the aid of a value of at least one further temperature from the same cycle and at least one of a second value of the fuel temperature and a further temperature from at least one previous cycle; and
checking whether a deviation of a temperature of the fuel temperature sensor lies within a first range around the first value of the fuel temperature.

2. The method as recited in claim 1, wherein a method for ascertaining a fuel temperature without a fuel temperature sensor is used to calculate a further change in the fuel temperature within the cycle.

3. The method as recited in claim 2, wherein the checking is performed periodically in order to check the fuel temperature sensor within at least one part of the cycle regarding whether the deviation of the temperature of the fuel temperature sensor from the ascertained fuel temperature lies within a second range.

4. The method as recited in claim 3, wherein the first range and the second range are different.

5. The method as recited in claim 4, wherein the second range is reduced one of (i) within one cycle or (ii) between two cycles.

6. The method as recited in claim 5, wherein the method for ascertaining a fuel temperature without a fuel temperature sensor is used to calculate a fuel temperature from at least one temperature and at least one other parameter of an injection system of an internal combustion engine.

7. The method as recited in claim 6, wherein, in the method for ascertaining a fuel temperature without a fuel temperature sensor, the at least one other parameter of the injection system is more accurately determined and checked with the aid of the temperature of the checked fuel temperature sensor.

8. The method as recited in claim 4, wherein the fuel temperature sensor is additionally checked by comparing the temperature of the fuel temperature sensor after the beginning of the cycle with the value of the at least one further temperature from the same cycle.

9. The method as recited in claim 4, wherein the monitoring of the fuel temperature sensor is used for onboard diagnosis.

10. A control unit for monitoring a fuel temperature sensor over a repeating cycle, comprising:
a controller including a computer processor configured to perform the following:
estimating a first value of a fuel temperature at the beginning of the cycle with the aid of a value of at least one further temperature from the same cycle and at least one of a second value of the fuel temperature and a further temperature from at least one previous cycle; and
checking whether a deviation of a temperature of the fuel temperature sensor lies within a first range around the first value of the fuel temperature.

11. A non-transitory computer-readable data storage medium storing a computer program having program codes which, when executed on a computer, perform a method for monitoring a fuel temperature sensor over a repeating cycle, the method comprising:
estimating a first value of a fuel temperature at the beginning of the cycle with the aid of a value of at least one further temperature from the same cycle and at least one of a second value of the fuel temperature and a further temperature from at least one previous cycle; and
checking whether a deviation of a temperature of the fuel temperature sensor lies within a first range around the first value of the fuel temperature.
